(19) United States
(12) Patent Application Publication
(10) Pub. No.: US 2005/0083233 A1
(43) Pub. Date: Apr. 21, 2005

(54) Patch antenna

(76) Inventors: Ziming He, Irvine, CA (US); Ping Peng, Irvine, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/687,299

(22) Filed: Oct. 15, 2003

(51) Int. Cl. H01Q 1/38

(52) U.S. Cl. 343/700 MS

(57) ABSTRACT

A patch antenna (1) for an electronic device includes a planar metal sheet having a first element (30), a second element (2) and a connecting patch (31) connecting the first element with the second element. A first ground plane (42) is disposed adjacent to the first element. A second ground plane (40) is parallelly spaced from the metal sheet. A shorted patch (41) shorts the first ground plane to the second ground plane. A number of dielectric sticks (6) are disposed between the metal sheet and the second ground plane for supporting the metal sheet. A feeder cable (50) includes an inner conductor (52) electrically connecting with the first element and an outer shield conductor (51) electrically connecting with the first ground plane.

### BACKGROUND OF THE INVENTION

1. Field of the Invention

The present invention relates to an antenna, and in particular to a patch antenna employed in an electronic device.

2. Description of the Prior Art or Related Art

In recent years, Wireless Local Area Network(WLAN) products under IEEE 802.11b standard, such as WLAN cards for computers and WLAN Access Points(APs) are gaining popularity in wireless communication market. Now WLAN cards under IEEE 802.11g standard (2.4-2.5 GHz) have introduced into broadband access application. These cards benefit from high gain antennas.

A communication device often employs a microstrip antenna for its low profile and low cost. One drawback of the traditional microstrip antenna is that it provides a very limited bandwidth which typically is 2-5 percent of the center frequency. Typically, the microstrip antenna can achieve limited bandwidth improvement by increasing the height of the physical space that exists between the antenna's radiating element and the ground plane. Unfortunately, as the height increases, the antenna's inductance also increases, which causes an impedance mismatch between the microstrip antenna and its feeder cable. The impedance mismatch will cause a portion of the feed power to be reflected to the signal source rather than to be radiated to the free space. The greater this reflected feed power, the less power that is radiated from the antenna, thus reducing the gain of the microstrip antenna. So the gain of the microstrip antenna is sacrificed to achieve wider bandwidth in such resolution. Another drawback is that a dielectric layer of the traditional microstrip antenna will introduce insertion loss (typically more than 2 dB), which does not fit a high gain application.

To achieve a wider bandwidth without expense of antenna's impedance mismatch, US. Pat. No. 4,605,933 discloses a broadband microstrip antenna with a high antenna gain. This microstrip antenna 10 comprises a circular radiating element 20 parallelly spaced from a lower ground plane 12 by an air gap. An upper ground 14 plane is shorted to the lower one 12, A thin dielectric layer 18 is disposed on the upper ground plane 14. A feeder line 30 and a coaxial-to-microstrip launch 28 are disposed on the upper ground plane 14.This microstrip antenna uses air gap as dielectric layer to improve antenna gain and two parallel ground plane to enhance antenna bandwidth. A match tab 24 extending from the lower ground plane 12 couples with the radiating element 20 to get a desired antenna impedance matching. A match strap 32 is disposed between the feed cable 30 and the coaxial-to-microstrip launch 28 for the microstrip antenna impedance matching.

However, when manufacturing this microstrip antenna, the match tab must be fabricated and mounted individually, which will add complex to manufacturing process. Furthermore, using two match elements increases cost of the microstrip antenna.

Hence, an improved antenna assembly is desired to overcome the above-mentioned disadvantages of the prior and related arts.

### BRIEF SUMMARY OF THE INVENTION

A primary object of the present invention is to provide a patch antenna having a simple structure while having a good antenna performance.

A patch antenna for an electronic device comprises a planar metal sheet comprising a first element, a second element and a connecting patch connecting the first element with the second element. A first ground plane is disposed adjacent to the first element. A second ground plane is parallelly spaced from the metal sheet. A shorted patch shorts the first ground plane to the second ground plane. A plurality of dielectric support-sticks are disposed between the metal sheet and the second ground plane for supporting the metal sheet. A feeder cable comprises an inner conductor electrically connecting with the first element and an outer shield conductor electrically connecting with the first ground plane.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a side view of a preferred embodiment of a patch antenna in accordance with the present invention.

FIG. 2 illustrates some dimensions of the patch antenna of FIG. 1.

FIG. 3 is a top view of the patch antenna of FIG. 1.

FIG. 4 is illustrates some dimensions of the patch antenna of FIG. 3.

FIG. 5 is the simulated result with Agilent ADS software for the patch antenna of FIG. 1, showing Voltage Standing Wave Ratio (VSWR) as a function of frequency.

### DETAILED DESCRIPTION OF THE INVENTION

Reference will now be made in detail to a preferred embodiment of the present invention.

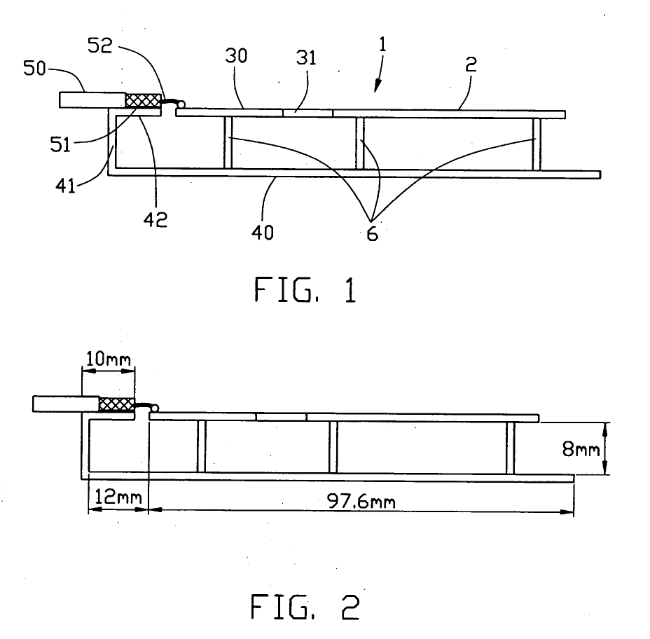

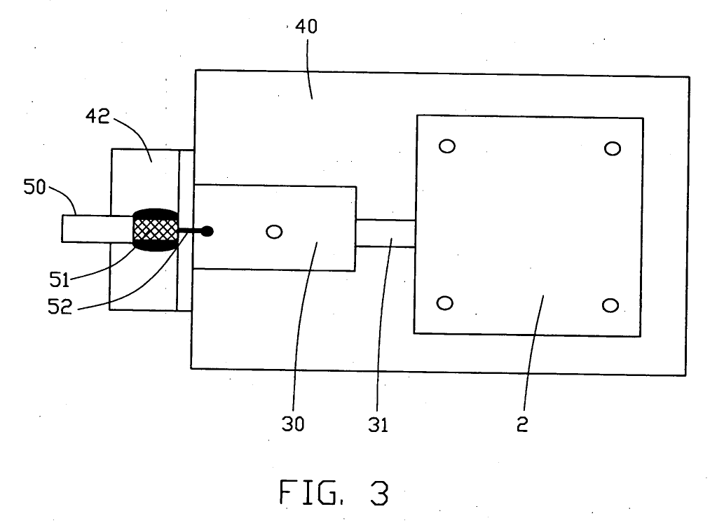

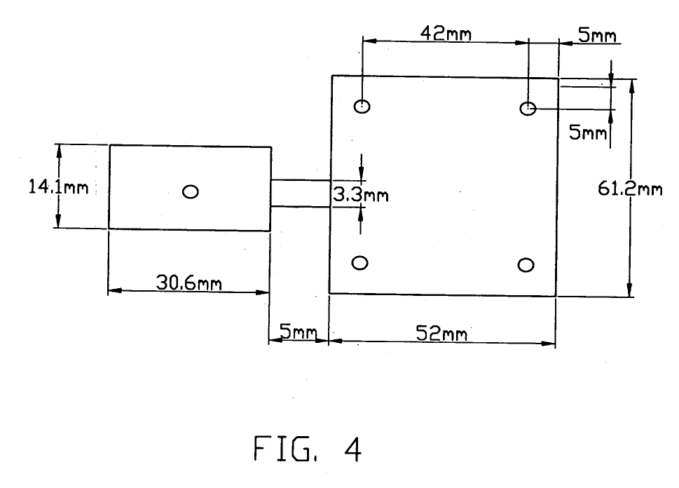

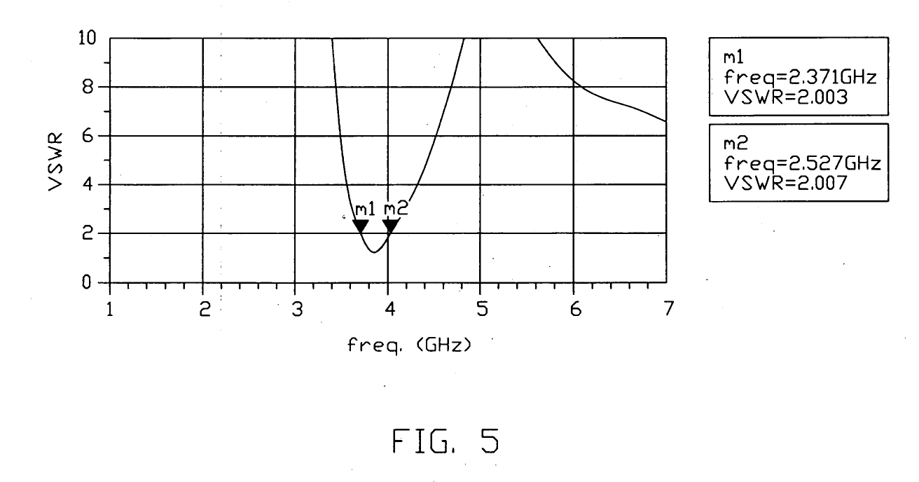

Referring to FIG. 1 and FIG. 3, a patch antenna 1 in accordance with the present invention received in a plastic spacer (not shown) comprises a radiating element 2, a match tab 30, an upper ground plane 42 coplanar with the radiating element 2, a lower ground plane 40, a plurality of dielectric support-sticks 6 and a coaxial feeder cable 50.

The lower and upper ground plane 40, 42 are parallel to each other and shorted by a shorting portion 41. The shorting portion 41, the lower and upper ground planes 40, 42 are all rectangular and integrally formed by a metal sheet. The shorting portion 41 extends perpendicularly from a left edge of the lower ground plane to a left edge of the upper ground plane 42. The upper ground plane 42 is disposed above the left portion of the lower ground plane 40 with a predetermined distance. The lower ground plane 40 is much larger than the upper one 42. The distance between the two ground planes 40, 42 is predetermined due to the requirement of the bandwidth and gain-of the patch antenna 1. The distance between the two ground planes 40, 42 increases, the bandwidth of the patch antenna 1 will also increase. But the increasing distance introduces impedance mismatch. Thus a matching element is needed.

A connecting portion 31, which has a characteristic impedance same as the input impedance of the radiating element 2, connects the match tab 30 with the radiating element 2. The match tab 30 is adjacent to the upper ground plane 42 with a predetermined distance due to the impedance matching between radiating element 2 and the feeder cable 50. The match tab 30, the connecting portion 31 and the radiating element 2 are all rectangular and formed by a flat metal patch. The flat metal patch is coplanar with the upper ground plane 42 and is supported by a plurality of plastic sticks 6 extending from the lower ground plane 40.

The feeder cable 50 is a coaxial cable. A top portion of the feeder cable 50 is coplanarly disposed on the upper ground plane 42. Portions of an outer dielectric layer and a shield conductor 51 are stripped to expose the inner dielectric layer. A little portion of the inner dielectric layer is stripped to expose an inner conductor 52. The inner conductor 52 extends outwardly to electrically connect with the match tab 30. The outer shield conductor 51 is electrically connected with the upper ground plane 42.

FIG. 5 shows the simulated result of Voltage Standing Wave Ratio (VSWR) of the patch antenna 1 as a function of frequency. Note that VSWR drops below the desirable maximum value “2” in the 2.37-2.52 GHz frequency band, indicating acceptably efficient operation in the frequency band.

Reference to FIG. 5, the bandwidth of the patch antenna 1 is 150 MHz which covers the bandwidth under IEEE 802.11b/g standards. The bandwidth is approximate 7 percent of the center frequency. In this embodiment, the antenna gain is more than 9 dB, which is not at expense of bandwidth but by adding the match tab 30 when manufacturing the radiating element 2.

Referring to FIG. 2 and FIG. 4, major dimensions of the patch antenna 1 are labeled thereon, wherein all dimensions are measured in millimeters (mm).

In another embodiment, a dielectric substrate may be inserted between the radiating element 2 and the lower ground plane 40 to reduce the sizes of the patch antenna 1 for the special application, such as being a built-in antenna. The distance between radiating element 2 and the lower ground plane 41 can be increased to enhance the bandwidth of the patch antenna if a very high antenna gain is not necessary.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A patch antenna comprising:
a planar ground plane;
a radiating element parallelly disposed above the ground plane with a predetermined distance;
a plurality of dielectric supporting portions disposed between the ground plane and the radiating element for supporting the radiating element.
a match tab electrically connected with the radiating element; and
a feeder cable comprising an inner conductor electrically connecting with the match tab and an outer shield conductor electrically connecting with the ground plane.

2. The patch antenna as claimed in claim 1, wherein the ground plane comprises a main ground plane, a sub-ground plane disposed above the main ground plain and a shorted strap for connecting the sub-ground plane to the main ground plane.

3. The patch antenna as claimed in claim 2, wherein the cable outer shield conductor is electrically connected with the sub-ground plane.

4. The patch antenna as claimed in claim 3, wherein the sub-ground plane is coplanar with the match tab.

5. The patch antenna as claimed in claim 4, wherein the match tab and the radiating element are formed by one metal sheet.

6. The patch antenna as claimed in claim 1, wherein said radiating element and match tab are coplanar with each other.

7. A patch antenna for an electronic device, comprising:
a planar metal sheet comprising a first element, a second element and a connecting patch connecting the first element with the second element;
a first ground plane disposed adjacent to the first element;
a second ground plane parallelly spaced from the metal sheet a predetermined distance;
a shorted patch connecting the first ground plane to the second ground plane;
a plurality of dielectric supporting portions disposed between the metal sheet and the second ground plane to support the metal sheet; and
a feeder cable comprising an inner conductor electrically connecting with the first element and an outer shield conductor electrically connecting with the first ground plane.

8. The patch antenna as claimed in claim 7, wherein the first ground plane is coplanar with the metal sheet.

9. The patch antenna as claimed in claim 8, wherein the feeder cable lies on the first ground plane.

10. The patch antenna as claimed in claim 9, wherein the first and second elements are both rectangular.

11. The patch antenna as claimed in claim 7, wherein the first element and the second element are coplanar with each other.

12. A patch antenna for an electronic device comprising:
a first element, a second element and a connecting patch connecting the first element with the second element;
a ground portion disposed adjacent to the first element; and
a feeder cable comprising an inner conductor electrically connecting with the first element and -an outer shield conductor electrically connecting with the ground portion;
wherein the connection patch has a characteristic impedance same as that of the input impedance of the second element.

13. The antenna as claimed in claim 12, wherein a plurality of dielectric supporting portions are disposed between the metal sheet and the ground portion to support the metal sheet;

14. The patch antenna as claimed in claim 13, wherein the first element, the second element and the connecting patch are formed in one metal sheet.

15. The patch antenna as claimed in claim 14, wherein the ground portion comprises an upper ground plane, a lower ground plane and a short patch connecting the upper ground plane to the lower ground plane.

16. The patch antenna as claimed in claim 15, wherein the outer shield conductor electrically connects with the upper ground plane.

17. The patch antenna as claimed in claim 16, wherein the metal sheet is parallel to the lower ground plane.

18. The patch antenna as claimed in claim 12, wherein said first element and said second element are coplanar with each other.
